(19) United States
(12) Patent Application Publication
(10) Pub. No.: US 2013/0088511 A1
(43) Pub. Date: Apr. 11, 2013

(54) E-BOOK READER WITH OVERLAYS

(71) Applicants: Sanjit K. Mitra, Santa Barbara, CA (US); Asad M. Madni, Los Angeles, CA (US); Balineedu Chowdary Adsumilli, San Mateo, CA (US)

(72) Inventors: Sanjit K. Mitra, Santa Barbara, CA (US); Asad M. Madni, Los Angeles, CA (US); Balineedu Chowdary Adsumilli, San Mateo, CA (US)

(21) Appl. No.: 13/536,825

(22) Filed: Jun. 28, 2012

Related U.S. Application Data
(60) Provisional application No. 61/545,520, filed on Oct. 10, 2011.

(51) Int. Cl. G09G 5/00

(52) U.S. Cl. 345/629

(57) ABSTRACT

An e-book reader application for the desktop, laptop, tablet, or other mobile computing device configurations, and web/cloud environments provides user interactions with overlays that present the reader with immediate access to assets including equations, figures, references, index, source code, equation variables, and other parameters (including but not limited to graphical plots, videos, slide presentations, etc.) referenced in a given page using a pop-up window or a tool-tip to display the desired asset. The e-book reader application also provides additional tools such as sharing code and review materials, setting access restrictions, and tagging audio/video presentations for authors as well as highlighting, bookmarking, and notes-taking capabilities for readers.

### CROSS-REFERENCE TO RELATED APPLICATIONS

This application claims the benefit of U.S. Provisional Patent Application No. 61/545,520 “E-Book Reader with Overlays,” filed in the United States Patent and Trademark Office on Oct. 10, 2011.

### BACKGROUND

The cost of publishing a book in printed form is increasing very rapidly. A number of companies have turned to publishing books in electronic form that can be downloaded from the Internet. These e-books may be considerably less expensive than their physical counterparts and do not require physical space for storing them for future retrieval. As a result, the e-books have become the books of choice for many readers. In fact, in early 2011, Amazon.com® sales of e-books surpassed those of print books.

The format and layout used in current commercially available e-books allow a reader using, for example, the Amazon® Kindle®, the Barnes & Noble® Nook®, or the Sony® Reader® to read page by page in a sequential fashion. Buttons are provided in the frame holding the display screen or a touch sensitive panel is provided to go back or forward between pages on display. With the addition of software-based e-book reader application on other forms of computing devices like Apple iPad®, a certain amount of minimal interactivity is provided for zooming and video/audio playback.

However, these reader devices are not suitable for certain types of books such as scientific, technical, and legal texts, in which a reader may often need to go back to a specific topic on an earlier page. For example, in a page, the author may refer to an equation or a figure or a definition of a term introduced earlier. Equations or the figures are typically numbered sequentially to identify the chapter where it first appeared, the reader typically has to flip through almost every page of the chapter to locate the referred-to equation or figure. To locate a term, the reader often has to go to the Index pages to find the corresponding page number(s). Additionally, in the case where the buttons are fixed in the frame, the same buttons are shown irrespective of the type of book. Typically, these buttons are not suitable for scientific, technical, and legal texts, and changing these buttons is not possible.

### SUMMARY

Embodiments of the present invention are directed to an e-book reader application for the desktop, laptop, tablet, or other mobile computing device configurations, and web/cloud environments. The reader application includes innovative user interactions with overlays that are rich, intuitive, easy-to-use, and electronic publication friendly, and targeted for easy reading/understanding of scientific, technical, medical, and law texts. The interactive overlays in the application present the reader with enriched learning experience with immediate access to equations, figures, references, index, code, equation variables, and other parameters (including but not limited to graphical plots, videos, power point presentations, etc.) referenced in a given page (but introduced in a previous page, or in the case of references listed in later pages) using a pop-up window or a tool-tip to get to the desired asset. The design for the interaction is novel and layered (as basic as using different colors to represent various reference elements and as intricate as having data points and curve equations displayed that change values when interacting with a figure for a plot). The application also provides additional tools such as sharing code and review materials, setting access restrictions, and tagging audio/video presentations for authors as well as highlighting, bookmarking, and notes-taking capabilities for readers. An e-book reader application using the innovations described here would (a) improve the learning effectiveness of the user reading the text, (b) reduce the costs when compared to printed books, and (c) make the user experience richer and more enjoyable.

For example, according to one embodiment of the present invention, assume in a page in Chapter 8 of an e-book, the reader is referred to an equation numbered Eq. (5.7) appearing in Chapter 5 of the e-book. To make it easier and faster to find this equation, the equation (or the text “Eq. (5.7)”) appears in a specific color (or may be highlighted) in that page in Chapter 8 (to identify it as text that can be clicked), and the reader can click on this colored equation number which will then open a new window on top of current page (e.g., an overlay or pop-up window) showing this equation. In another embodiment, the overlay or the pop-up window is made interactive, where the reader can further click on the terms of the equation to get their explanation, or enter values and observe the dynamically changing result. Likewise, assume in a page in Chapter 8 of the e-book, the reader is referred to Figure 4.9 appearing in Chapter 4 of the e-book. In this case also, Figure 4.9 (e.g., the text “Figure 4.9”) will appear in a specific color in that page in Chapter 8 of the e-book, and the reader can click on this colored figure number, which will open a pop-up or an overly window showing Figure 4.9. Like in the case of equations, this pop-up window is made interactive, where the reader can further click on the figure to zoom in and out, or click on a plot to get sample data points.

Similarly, a term that has been introduced earlier will show up in a color different from that being used for equations and figures in a later page. The reader can click on the colored term, which then opens up a window displaying the text where the term first appeared. Also, the reference symbol in the text will appear in another color and clicking on it will open up a window containing the details about the reference, be it a publication, an http link, or a document in the computing device where the application resides. In addition, detail URLs can be provided for certain types of references, such as journal and conference papers, reports, etc. Embodiments of the present invention also provide the direct linking of a problem to its solution for faculty members who have adopted the e-book for teaching a course. This particular access function can be password protected for use by faculty members only.

Publishing a book in electronic format also allows colors to be easily included for easy reading of text and display of figures and plots which is not possible with black and white e-book reader devices. Though there has been a recent push by companies like Google® and Amazon® toward converting print books to electronic ones, these efforts have predominantly involved scanning the print versions of scientific and legal texts and displaying them as PDFs. This conversion and the chosen display formats do not leverage the full capability of electronic publishing and falls short in making the reading experience interactive. In embodiments of the present invention, advantages of electronic publishing, particularly in the case of scientific, technical, and legal texts, are used to provide a richer and more enjoyable learning experience. Electronic publishing also allows for easier corrections of errors and rapid publication of reprints which is not possible with a simple scanned conversion. In addition, highlighting and annotation capabilities can be easily included. Electronic format allows for easy change in font sizes (along with zooming and interaction capabilities for pictures and other elements), which leads to better reading and viewing. Also, annotations can be grouped into classes and a Microsoft Word® or Adobe® PDF document containing the appropriate annotations (e.g., in a particular class/group) can be listed in a specific document for easy access. Additionally, software buttons can be provided within the electronic reader application that vary in their functionalities and appearance (e.g., size and shape) based on the type and content of the book.

According to one embodiment of the present invention, an electronic book reader includes: a computing device including: a memory, a signal processor, a user interface, and a display, the computing device being configured to display a first portion of an electronic book on a main portion of the display, the electronic book being stored in the memory, the signal processor being configured to load the electronic book from the memory and to display the electronic book on the display, and the electronic book including at least one reference from the first portion of the electronic book to an asset in a second portion of the electronic book, the display being further configured to show the second portion of the electronic book as an overlay when the at least one reference is selected via the user interface.

The computing device may be a desktop computer, a laptop computer, a tablet computer, or another mobile computing device.

The asset may be a figure.

The figure may be displayed in the overlay and may include labels, titles, and legends of the graphs, maps, and diagrams.

The overlay may include: a first display configured to display the data point values in a graph/plot in accordance with a user selection; a second display configured to display the equation used to generate the graph/plot; a first control configured to set one or more values of one or more of variables of the equation used to generate the graph/plot; and a second control configured to change the shape of the graph/plot/curve in accordance with the user selection; wherein the user interface is configured to control the first control and the second control, wherein the first display is configured to dynamically update the display of the graph/plot in accordance with the one or more values of the one or more variables of the equation set by the first control, and wherein the second display configured to dynamically update the display of the equation in accordance with the one or more values of the one or more variables of the equation set by the first control.

The asset may be an equation.

The equation displayed in the overlay may include definitions of variables of the equation.

The overlay may include: a control configured to set a value of the equation displayed in the overlay; and a display configured to display an evaluated output of the equation in accordance with a value set by the control and the user interface may be configured to control the control.

The asset may be a section of the electronic book.

The memory may be configured to store a searchable index of words in the electronic book, wherein the searchable index of words associates each of a plurality of words to one or more locations in the electronic book.

The computing device may be further configured to receive a search query entered via the user interface, and wherein the computing device may be further configured to return a list of locations in the electronic book, the list of locations corresponding to the search query.

The asset may be an entry in a glossary stored in the searchable index of words.

The computing device may be further configured to display the second portion of the electronic book on the main portion of the display in response to a command received from the user interface.

The computing device may be configured to control the display to indicate the one or more references on the display based on a type of the asset.

The reference of the one or more references may be displayed in a first color when the asset is a figure and the another reference of the one or more references may be displayed in a second color different from the first color when the asset is an equation.

The memory may be further configured to store an annotation received from the user interface and associated with the first portion of the electronic book.

The annotation may include a reference to the asset.

The annotation may include a copy of the asset.

Annotations of same type of assets may be combined together for storage.

The asset may be associated with an asset security restriction, wherein the user interface may be configured to receive login credentials for a user account associated with one or more account security restrictions, and wherein the computing device may be configured to grant or deny access to the asset in accordance with the asset security restriction and the one or more account security restrictions associated with the user account.

The asset may be a bibliographical reference, an online reference, or a reference to another electronic book that may be stored in the memory.

The asset may include a software program.

The asset may include practice problems, practice exercises, or review materials.

The asset may include supplemental slides.

The asset may include audio, video or other multimedia material.

The computing device may be configured to control the display to indicate the location of the asset on the display based on the asset being in the first potion of the electronic book or the second portion.

### BRIEF DESCRIPTION OF THE DRAWINGS

The accompanying drawings, together with the specification, illustrate exemplary embodiments of the present invention, and, together with the description, serve to explain the principles of the present invention.

FIG. 1(a) is a diagram illustrating the overall design layout of an e-reader application according to one embodiment of the present invention.

FIG. 1(b) is a diagram illustrating multiple, similar classes of data types depending from a common parent class according to one embodiment of the present invention.

FIG. 2 is a flowchart illustrating the overall flow control of an e-book application according to one embodiment of the present invention.

FIG. 3 is a flowchart illustrating an implementation and exposed interfaces of contents and sections class according to one embodiment of the present invention.

FIG. 4 is a flowchart illustrating an implementation and exposed interfaces of an equations class according to one embodiment of the present invention.

FIG. 5 is a flowchart illustrating an implementation and exposed interfaces of a references class according to one embodiment of the present invention.

FIG. 6 is a flowchart illustrating an implementation and exposed interfaces of a datahead class according to one embodiment of the present invention.

FIG. 7 is a flowchart illustrating an implementation and exposed interfaces of a figures class according to one embodiment of the present invention.

FIG. 8 is a flowchart illustrating an implementation and exposed interfaces of a pages class according to one embodiment of the present invention.

FIG. 9 is a flowchart illustrating an implementation and exposed interfaces of an index class according to one embodiment of the present invention.

FIG. 10 is an illustration of a browsing-based Datahead user interface according to one embodiment of the present invention.

FIG. 11 is an illustration of a category-based Datahead user interface according to another embodiment of the present invention.

FIG. 12 is an illustration of a contents and section menu user interface and a popup interface associated with another section in an e-book according to one embodiment of the present invention.

FIG. 13 is an illustration of a user interface for displaying equations according to one embodiment of the present invention.

FIG. 14 is an illustration of a user interface for displaying figures according to one embodiment of the present invention.

FIG. 15 is an illustration of a user interface for displaying references to other documents according to one embodiment of the present invention.

FIG. 16 is an illustration of a user interface for displaying keyword-definition pairings according to one embodiment of the present invention.

### DETAILED DESCRIPTION

Embodiments of the present invention relate to an e-book application for scientific, technical, legal and similar types of texts. In designing this application, embodiments of the present invention provides an easier, quicker access to referred objects in texts. Embodiments of the present invention also provide the reader with exceptional ease of use when reading technical books published in electronic format. In doing so, various embodiments of the invention provide information to readers without requiring the readers to deal with a complex and cluttered user interface.

Additionally, embodiments of the present invention may be tailored to cater to various kinds of books, devices, interfaces, and usage patterns and formats.

Embodiments of the present invention are capable of identifying, accepting, and displaying multiple document formats. Document formats may include, but are not limited to: Portable Document Format (.pdf), Adobe® PostScript® (.ps), Microsoft® Word® (.doc), TeX/LaTeX (.tex), ePub (.epub), HTML (.html), and XML (.xml).

Other free publicly or proprietary publisher-specific formats may be used in some e-books and embodiments of the present invention make the e-reader application scalable to include them.

Embodiments of the present invention may be developed in a variety of computer languages and technologies. The particular language or technology used may be chosen based on device and interface choices.

Aspects of embodiments of the e-reader application's design details include:

a) Using different colors for different referred objects. Each colored object is a separate class. This provides for flexibility and scalability.

b) Though a few of the classes are logically abstract, most of the classes are required to expose an interface. This provides a contract between itself and other classes and makes the flow (communication) between classes easier.

c) In user-interface (UI) related operations, the interfaces act more like Application Program Interface (API) calls, but are well integrated with objects. This way, if the interface changes from mouse-operated to finger-operated, the objects' implementation need not change. All API calls are local, and used specifically by other application as well as UI objects.

d) Application-wide operational components such as search and random access (seek) are integrated both in main flow as well as individual object functionality.

In addition, certain implementation specific design considerations could possibly take shape during the process of developing embodiments of the present invention.

From the design considerations, it follows that most of the operations are modular and object specific. We provide here details of how the different objects we consider are designed, i.e., their functionality and operational flow.

1. Operations

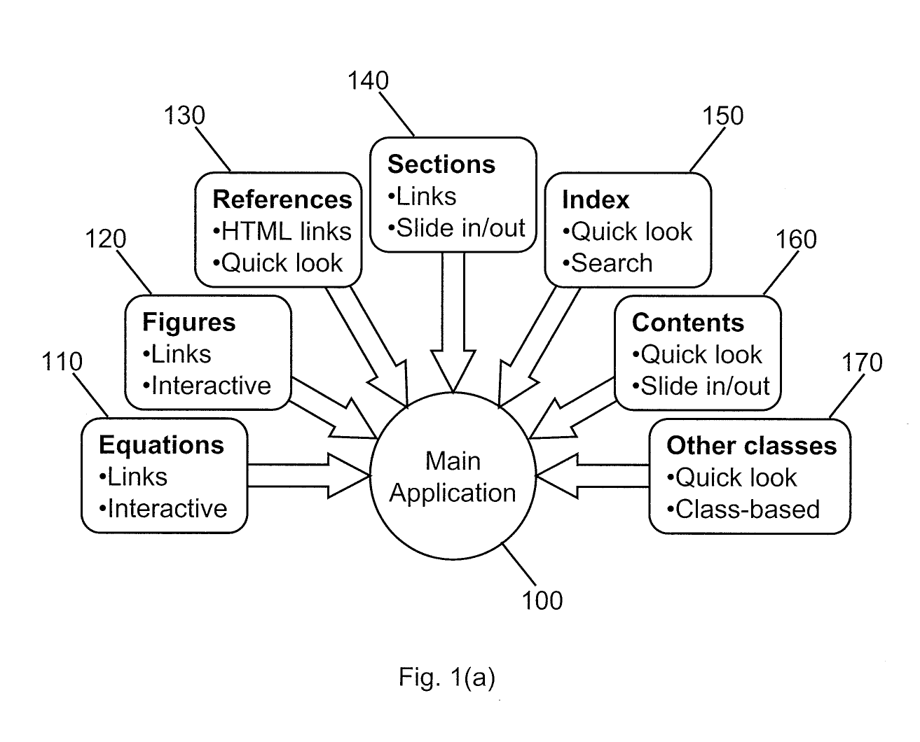

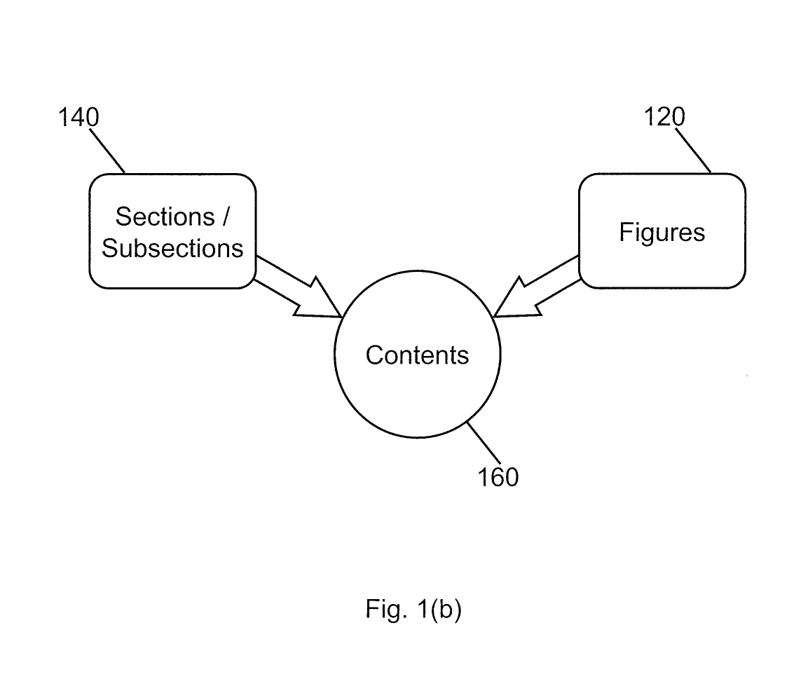

To accurately define their operations, the objects involved in the application will be identified according to one embodiment of the present invention. Any of the referred material in the text is treated as a separate object, i.e., the equations, figures, sections, subsections, references, index, and contents are all separate objects. A separate color is used to identify each of these objects. From our design considerations, we mentioned that each of the colored referred objects is a class. Therefore, we have separate classes for each of these objects. (For example, all equation objects in the document are instances of the equation class.) The overall design layout of the application is shown in FIGS. 1(a) and 1(b). The design for the classes and their contracts with the main application is scalable and can be extended to include additional objects, if necessary, from the main subject area of the e-book.

FIG. 1(a) is a diagram illustrating the overall design layout of objects in an e-reader application according to one embodiment of the present invention. Referring to FIG. 1(a), a main application 100 operates to display an e-book on a user interface. The e-book data may include (but is not limited to) classes of data such as equations 110, figures 120, reference 130, sections 140, index 150, contents 160, and other classes (of data) 170.

FIG. 1(b) is a diagram illustrating that Related Objects that have one or two elements of common functionality can be linked to and/or derived from a common parent class. In the example of FIG. 1(b), the sections/subsections 140 data class and the figures 120 data class may both be linked to or derived from the contents 160 data class.

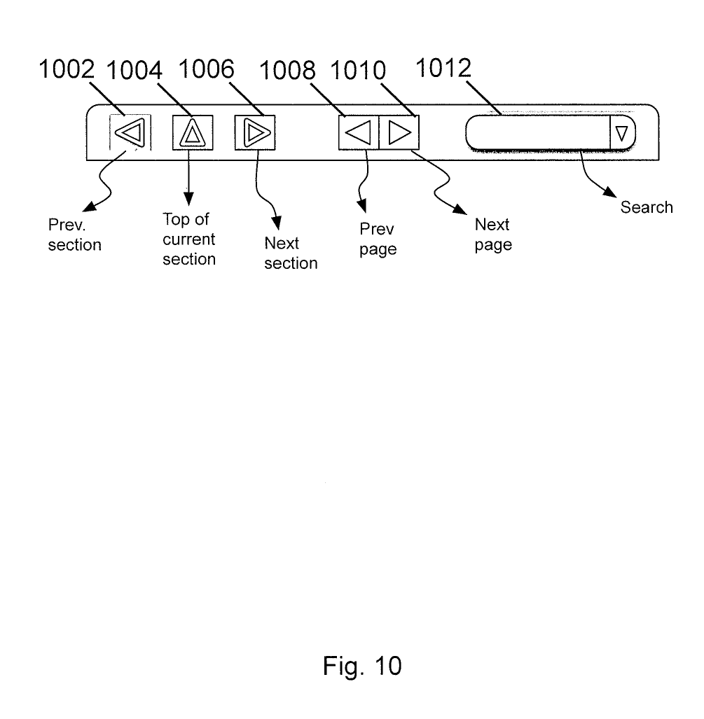

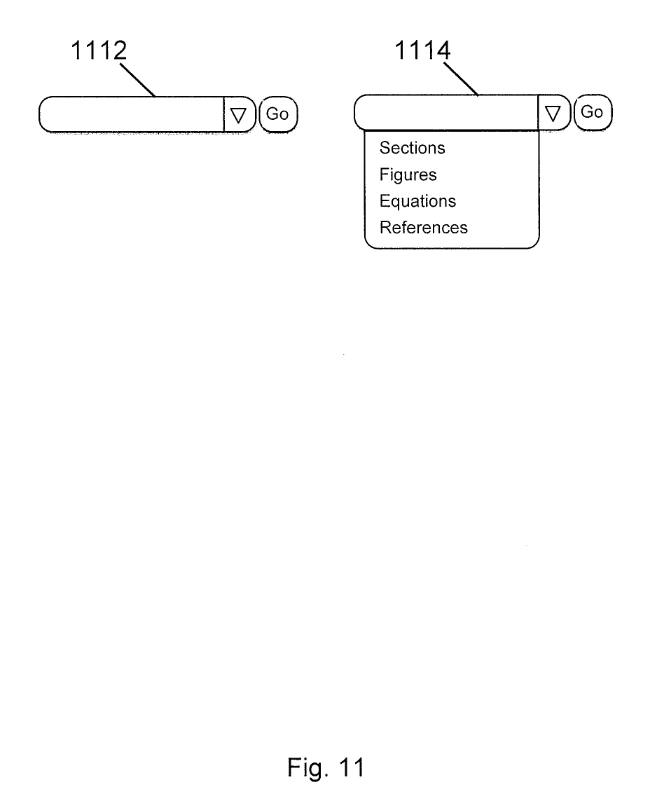

In one embodiment, in addition to the above described objects, a Datahead is built into the main application. The function of the Datahead is to display, in every page, the common functionalities such as fast random access (seek to chapters, sections, and pages) and search. For example, Referring to FIGS. 10 and 11, the Datahead may be used to provide a floating toolbar at the top or bottom of the user interface to allow a user to jump to particular chapters, sections, or page numbers of an e-book or to search for particular keywords within the e-book.

Additional details of the above-defined objects according to embodiments of the present invention will be described below and their functionalities will be explained with the help of some flow diagrams.

1.1 Main Application Flow

According to one embodiment of the present invention, the entire application is implemented as per the Model-View-Controller (MVC) software architecture pattern. This helps in separating the application processes from the UI and creating individual interfaces for various objects.

In an embodiment using an MVC design pattern, the main application could be present in any one of the four states at any time; the pre-login state where the user is expected to login, the initial state where the application is open by not displaying any books or papers, the running state where the application is listening to and handling events, and the logout state where the application stores a set of key values before logging out the user.

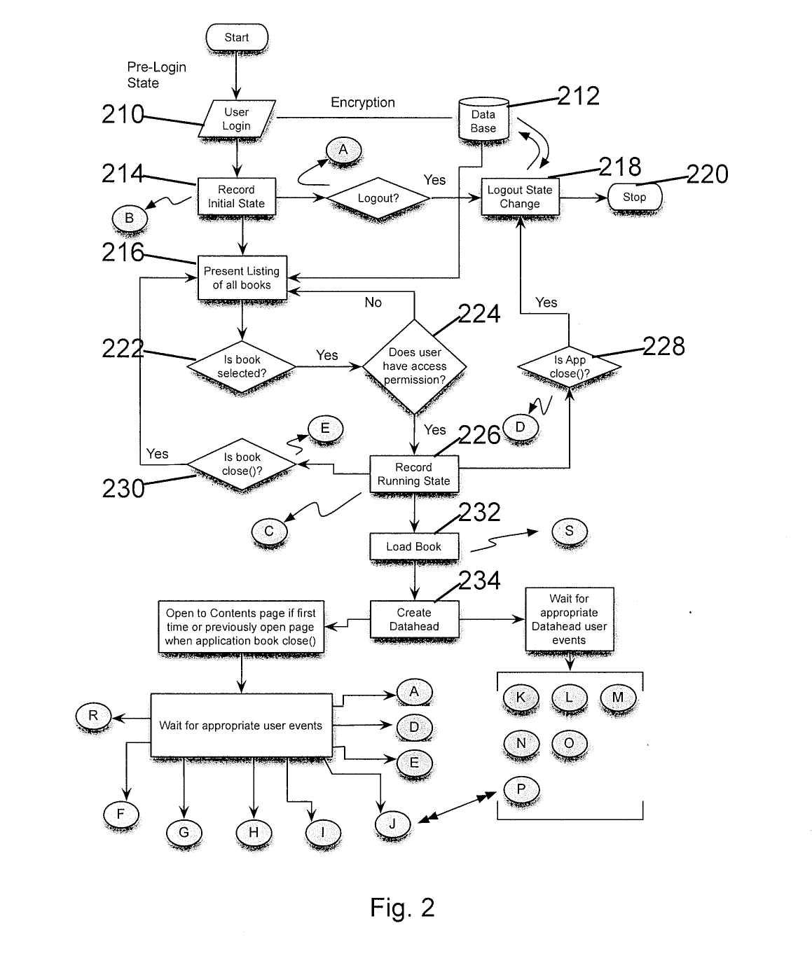

The flow of the main application of one embodiment is event-based. These events are triggered either by the system or by the user. For the purpose of explanation, each event is represented in the figures here using a circled letter. Table 1 is a list of events and brief descriptions thereof according to one embodiment of the present invention. FIG. 2 is a flowchart illustrating events (A) through (S), which shows the overall control flow of the main application according to one embodiment of the present invention. Events (A) through (E) and (S) are explained in this subsection, while event (F) is detailed in Section 3.2, event (G) in Section 3.3, event (I) in Section 3.4, event (H) in Section 3.5, events (K) through (Q) in Section 3.6, event (R) in Section 3.7, and event (J) in Section 3.8.

TABLE 1
List of events according to one embodiment of the present invention.

| Event | Description |
|---|---|
| A | Log out event |
| B | Initial state recorder event |
| C | Running state event |
| D | Application close event |
| E | Book or paper close event |
| F | Chapters and Sections initialize event |
| G | Equations initialize event |
| H | Figures initialize event |
| I | References initialize event |
| J | Index initialize event |
| K | Previous chapter datahead event |
| L | Top of the current chapter datahead event |
| M | Next chapter datahead event |
| N | Previous page datahead event |
| O | Next page datahead event |
| P | Search datahead event |
| Q | Categorical search datahead event |
| R | Page flips and state maintenance event |
| S | Document loader event |

Referring to the embodiment shown in FIG. 2, the application starts in the pre-login state where the user login credentials are requested 210. Once received, the user is verified with the credentials present in a secure encrypted database 212, and the initial state of the application is recorded 214. A list of the all the books/papers/journals that the user has either previously purchased or has access to from the application is then loaded and presented to the user for selection 216. Additionally, an event listener is added for listening to a log out event (A), as the user can log out any time during his ‘stay’ in the application. If the user triggers (A), then the book, its page location, any highlighted information, and other saved information is stored during event handling. The state changes to logout 218 and the application exits 220.

If the user book selection event is triggered 222 during the initial state (B), the selected item is cross-referenced against the database to check whether the user has the correct permissions to view the book 224. These permissions could change based on type of user, type of account, time of availability, etc. Once the book has been “approved” to be viewed, the state of the application changes to running state (C) 226. Additionally, two other event listeners are added; the application-close event listener (D) 228 and the book close event listener (E) 230. These events can be triggered anytime during the application for closing the application, and closing the opened book, respectively.

Alternatively, the user also has the option of loading a file from the local directory structure of the computing device. For the application to load and display the file properly, it uses a document loader event (S) 230, which allows the operation to flow smoothly. The event handler of (S) will verify whether the book is in an acceptable preselected format that is ‘understood’ by the application. If so, it processes the class objects and adds it to the repository.

The application then creates the datahead 234 and initializes the required interface events. While in running state with event listener for (C), the application builds the backend for events (F) through (J), and (R), opens the book for user perusal, and adds the corresponding event listeners.

1.2 Contents and Sections

According to one embodiment of the present invention, the implementation of the contents and sections class provides three interfaces.

The first interface is the class initialize interface. This creates a reference to the contents menu in the opened book and initializes all the required parameters for the smooth operation of the class.

According to one embodiment, the events that are produced in this class are internal and cannot be accessed or called from outside the class instance.

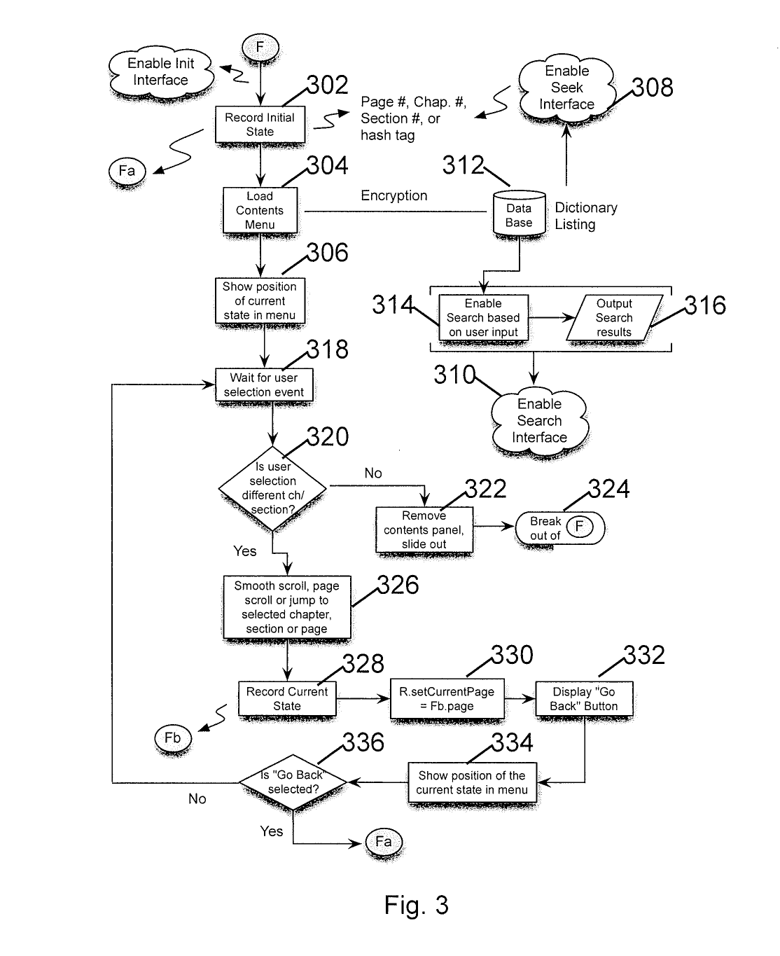

FIG. 3 is a flowchart illustrating the general implementation of Contents and Section operations according to one embodiment of the present invention. The initial state is recorded 302 and an event listener (Fa) is added for state change notification. The parameters for recording the state include the current page number, the chapter number, section or subsection number, or a search hash tag. The contents menu is then created 304 by loading and indexing the contents, sections, and subsections to the corresponding page numbers.

The created contents menu is concurrently displayed and stored (e.g., in database 312). During the storing process, a dictionary listing is created and can provide seek operations. In some embodiments, the storage is encrypted for shielding access from external interfaces. The seek interface 308 is the second interface that the implementation exposes.

The third interface is the search interface 310. The dictionary listing could additionally provide search functionality where the input 314 to the search could be the chapter number, section or subsection number, and the output 316 could be the page number. This interface may be used for the event (P) discussed in Section 3.5.

During the display of the contents menu (e.g., via a slide out panel), the current state (chapter or section) could be highlighted to let the user identify his/her ‘location’ in the book 306. If the user selects the same chapter or section he/she is in, or if the user unselects the contents menu 320, the contents panel is closed 322 (e.g., the contents menu slides back in). In this case, as is the case with completion of the book, the implementation breaks out of (F) handler 324, and the control goes back to the main application with the process at the event listener (C).

Otherwise, if the user selects a chapter or a section that is separate from the current state, then the UI either smooth scrolls, page scrolls, or jumps to the selected chapter, section, or subsection 326. In this case, the new state is recorded 328 and the state change event (Fb) is updated with current information 330.

While the menu is still open, the current state is highlighted 334 for the user to identify his/her ‘location’ in the book. Additionally, the user can see a “Go Back” button to go back to handling (Fa) 332. However, if the “Go Back” button is not selected, then the application assumes that the user has chosen to remain in the current state. The application updates the state and modifies its event listeners such that old(Fa)=old(Fb) and new(Fb)=null. This way, the user can choose to browse to different locations in the book using the contents menu.

1.3 Equations

Similar to the contents and sections class implementation, according to one embodiment of the present invention, the equations class implementation also exposes the initialize interface, which obtains the list of all equations from the book.

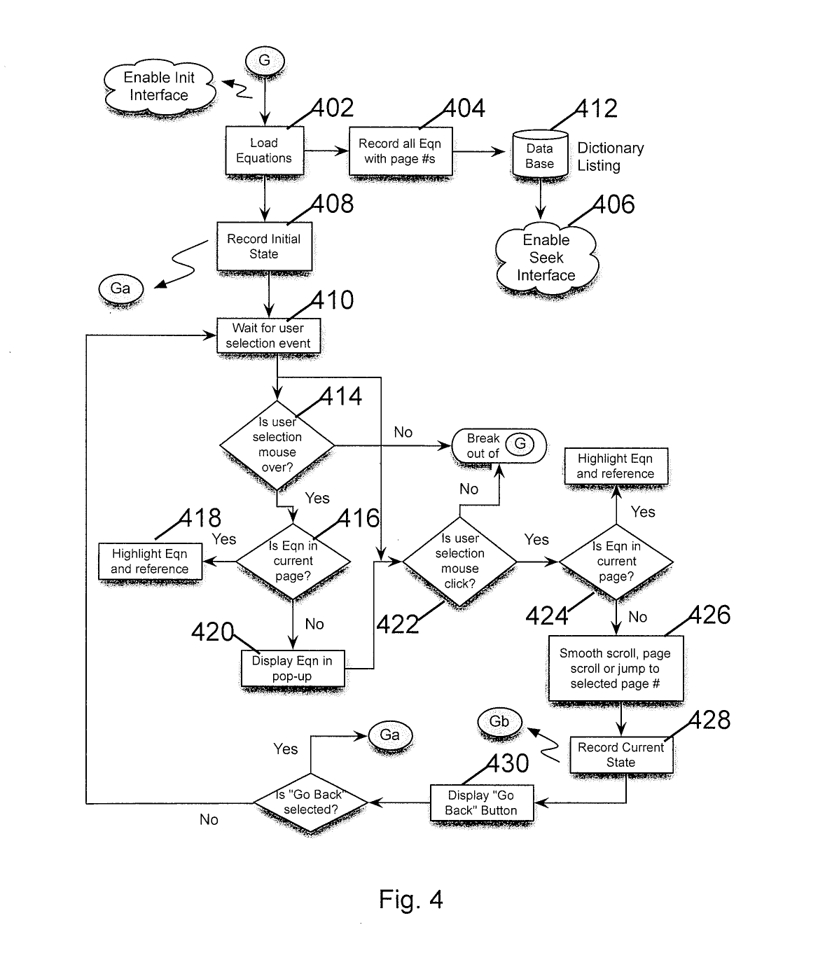

FIG. 4 is a flowchart illustrating a method of displaying equations according to one embodiment of the present invention. Referring to FIG. 4, the e-book application loads the equations 402 and creates a hash-map of all the equations corresponding to their page numbers 404. This is stored in a database 412 and used for quick seeking functionality. The seek interface 406 is useful for processing the search event (P).

An event listener (Ga) is added for state change when the initial state is measured 408. The created contents menu is simultaneously displayed and stored. After this point, the implementation waits 410 for the user selection. If the user moves the mouse over 414 the equation (or otherwise triggers an appropriate event, e.g., by touching the equation on a touchscreen device), then a check 416 is performed to determine whether the equation is present in the current page. If it is present, then both the equation and the reference to the equation (in the current page) are both highlighted 418. Otherwise, the equation is displayed 420 in a new window, a pop-up window, or in the tool-tip. The distinction on where the equation is present is explained in Section 4.3.

If the user clicks 422 on either the reference to the equation or the equation itself that appears in the pop-up or the tool-tip, the above distinction is made again 424. This time, if the selected equation is not present in the current page, then the UI either smooth scrolls, page scrolls, or jumps to the selected equation 426. The new state is recorded and the state change event (Gb) is handled 428.

The user can see a “Go Back” button 430 to go back to handling (Ga). However, if the “Go Back” button is not selected, then the application assumes that the user has chosen to remain in the current state.

1.4 References

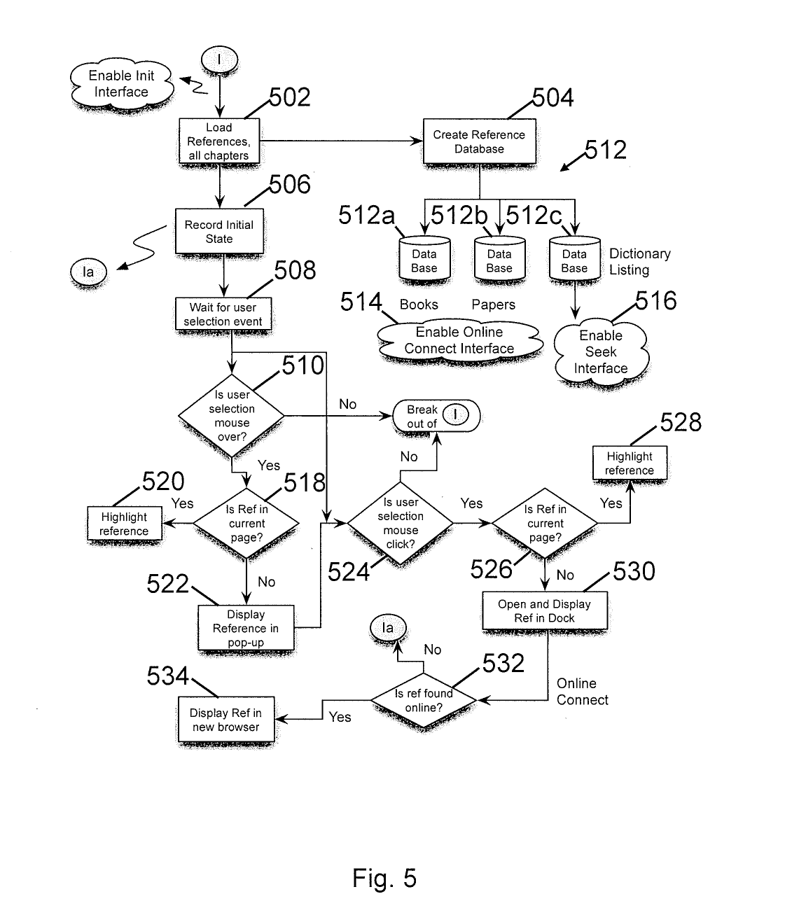

A flowchart illustrating class implementation and the exposed interfaces for the References class according to one embodiment of the present invention is shown in FIG. 5. The operation is similar to the previous class implementation with a few minor changes.

In a manner similar to that of other objects described above, the References class exposes the initialization interface, which loads 502 a list of all references in all the chapters and sections of the e-book. A reference database is created 504 using the loaded references.

In the embodiment shown in FIG. 5, three databases 512a, 512b, and 512c (collectively 512 {are created for the references, as the references are divided categorically into books, papers, and current book's directory listing. In other embodiments of the present invention, there may be fewer databases or more databases, in accordance with the number of categories of references. The first two databases 512a and 512b help in enabling the online connect interface 514, which connects to the Internet and searches for the public access to the referred text or paper, or technical article. The third database 512c helps in identifying the full reference of the article referred to in the text, and therefore enables the seek interface 516 with quick look-up functionality. The combination of all three databases 512 aids in providing the search interface to the references class.

After the initial state change event (Ia) 506, a distinction described above (and in Section 4.5) is implemented. For example, references interface waits for the selection of an event 508, detects whether the event is a mouse over 510, and highlights the selected reference 520 if the reference is in the current page 518 or otherwise displays a popup associated with the reference 522.

According to one embodiment of the present invention, after opening the reference “dock” (see Section 4.5 below for more details) and displaying the reference 530, the application uses the online connect interface and searches for the reference online 532. If the reference is found, it is displayed in a new browser window 534.

1.5 Datahead

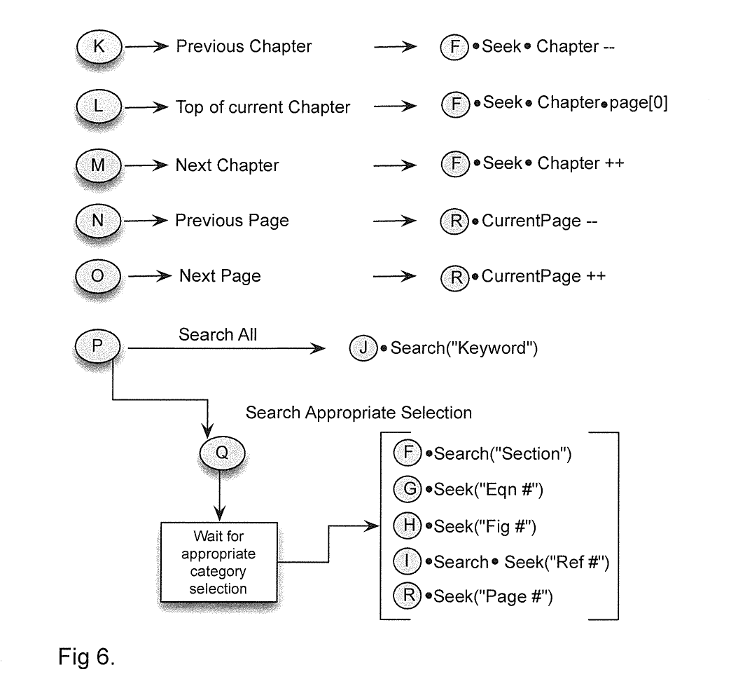

According to one embodiment of the present invention, the datahead interface is predominantly event driven. According to some embodiments of the present invention, the datahead is always available, and therefore the user can choose to click on its elements at any time during the use of the application. When selected, the appropriate event from events (K) through (O) is triggered, as shown, for example, in FIG. 6. The “bold dot” operations indicate the specific interfaces provided by the corresponding class.

For the event (P), if a search category is not selected, the implementation searches all of the text for the specific keyword. This is done using the interface of (J). However, if an appropriate category is selected, then the search is performed only in that category, based on the corresponding search/seek interfaces.

1.6 Figures

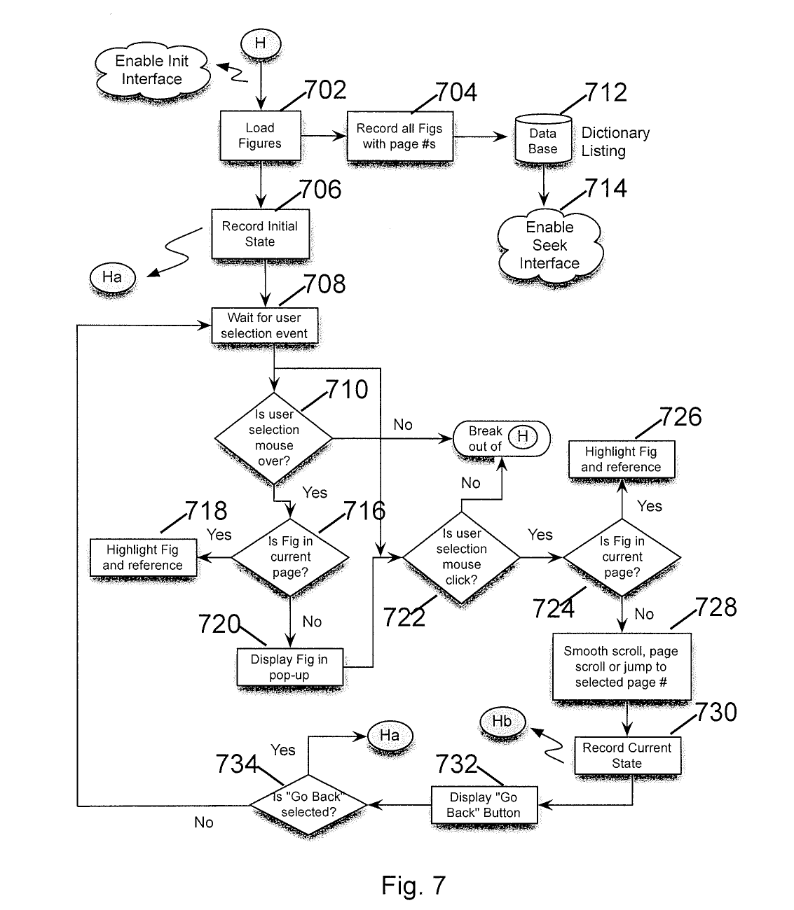

FIG. 7 is a flowchart illustrating an implementation of the Figures class and the available interfaces according to one embodiment of the present invention. As can be seen, the implementation is very similar to the implementation of the embodiment of the Equations class illustrated in FIG. 4. Figures are loaded 702 from the e-book and the figures, with page numbers are recorded 704 and stored in databse 712, which enables a seek interface 714. The initial state of the system is recorded and the flow waits for a user selection event 708. IF the user selection is a mouse over 710 and the figure is on the current page 716, then the figure and reference are highlighted 718. If not, then the selected (or hovered figure reference) is displayed in a pop-up 720. If the user selection is a mouse click 722, then, again if the figure is on the current page 724, it is highlighted 726. If not, on click, the current page is moved to the page number of the FIG. 728. A back button may then be displayed 732 and if the back button is selected, the document is returned to its state prior to selection (e.g., back to before the currently displayed page was changed to display the selected figure). Here again, the distinction is made whether the Figure that is referred to is present in the current page or not. The interfaces that the implementation exposes are the initialization interface and the seek interface. Both (G) and (H) give the control back to the main application during the handling of the (C) event.

1.7 Pages

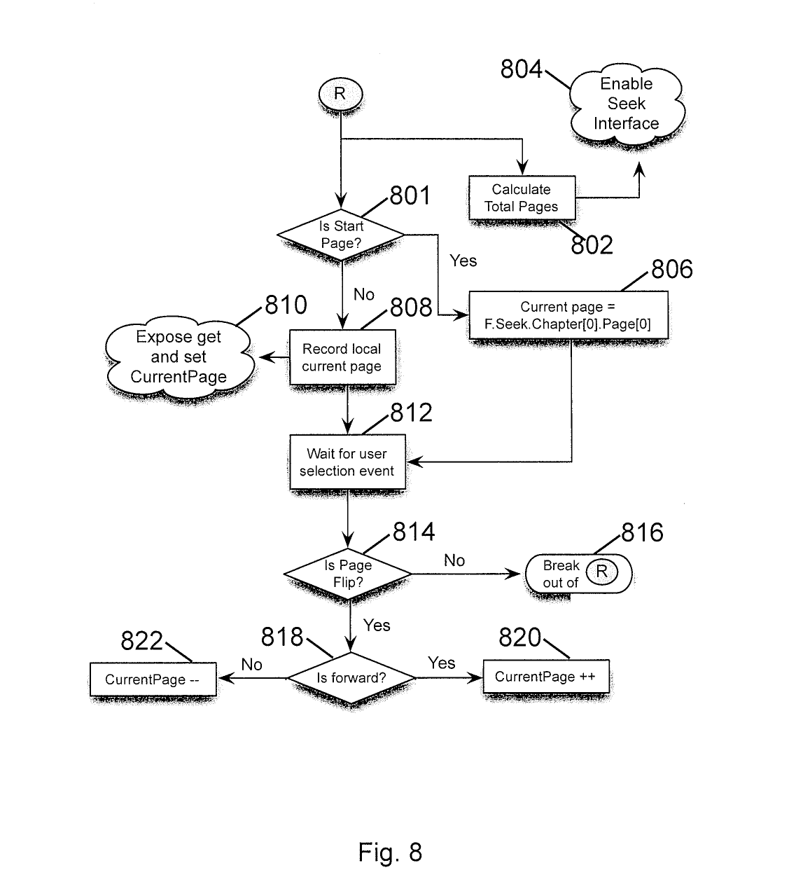

According to one embodiment of the present invention, the Pages class implementation, as shown in the flowchart of FIG. 8, and the interfaces it exposes are different from the ones previously examined.

When the pages event is triggered (typically at the beginning of the application, when the book is opened), the implementation checks 801 whether the CurrentPage is a start page or not, and sets the CurrentPage parameter to the appropriate value by seeking to the first page 806 or recording the current page 808. Additionally, it also loads the total pages 802 from the book and serializes them for fast and easy seek functionality 804. This implementation does not need a database or storage capacity for enabling the seek interface.

Though the seek interface 804 is somewhat similar to other classes' seek interfaces, the pages seek interface 804 also exposes 810 the “getCurrentPage( )” and the “setCurrentPage( )” methods which allow the other classes and the main application 100 to read/write the current page being read or viewed by the user. The application 100 having the capability to set the current page is particularly advantageous when the user jumps between chapters, sections, or pages using one the above described class operations.

If the user selects to flip pages 814, one after another, the implementation checks 818 whether the user is proceeding forward 820 or going backward for 822 each flip and updates the CurrentPage. The user could also have the option of smooth scrolling, page scrolling, or jumping to a particular page. This case however, would be similar to setting the CurrentPage to where the jump ends.

1.8 Index

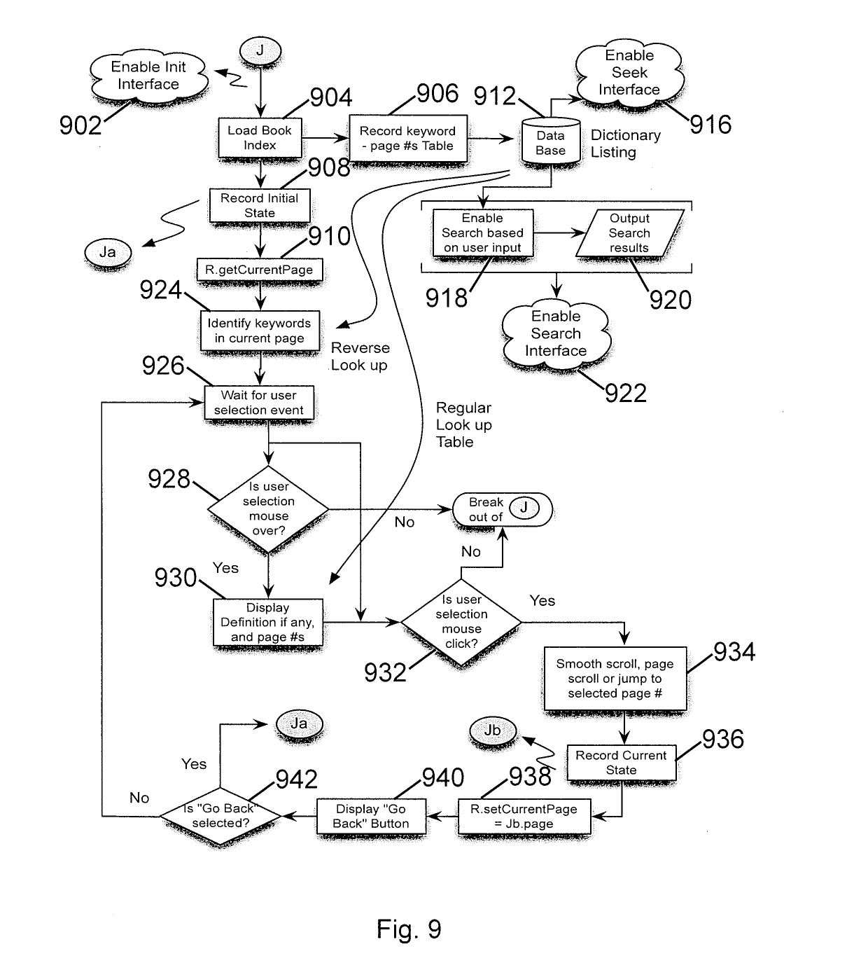

The initialization interface for the index class is similar to the ones discussed in Section 1.2-1.4. The implementation of the index class according to one embodiment of the present invention is shown in FIG. 9.

The initialization interface is enabled 902. The book index is obtained and loaded 904 from the e-book. This information is processed 906 to create a hash-table with the keywords to the corresponding page numbers (i.e., all the pages where the keywords are mentioned). From this, the dictionary listing is created and stored in a database 912, which enables quick seek functionality 916. The database 912 also provides quick search functionality 922 (returns page numbers 920 based on the keyword 918). The seek 916 and the search 922 provide the interfaces for the index class.

The initial state is recorded 918 and an event listener (Ja) is added for state change notification. The current page that the user is reading/viewing is obtained using (R) 910. In the current page, all the keywords are identified 924 using the hash-table reverse look-up of the database entries. If the user moves his mouse over the identified keyword 928, the definition of the keyword (if such a definition is available in a glossary stored in the hash-table) and the page numbers are obtained using a regular hash-table look-up of the database entries and displayed in a new window, a pop-up, or a tool-tip 930.

If the user clicks 932 on either the keyword or the pop-up window/tool-tip, the UI then smooth scrolls, page scrolls, or jumps to the page that has referred to the keyword for the first time 934. In this case, the new state is recorded 936 and the state change event (Jb) is updated along with setting the current page 938.

A “Go Back” button is displayed 940 to let the user go back to handling (Ja) 942. If the “Go Back” button is not selected, then the application assumes that the user has chosen to remain in the current state.

The above descriptions of the operations are highly interconnected with the user interactions of the application. User interface (or UI) “plugs” or API calls take advantage of producing the correct UI component for the correct interface. When the user interacts with the elements of a particular interface, an internal API call is made to the corresponding UI component and the resulting UI is rendered to the user. The main application decides the flow of these calls activating and de-activating the required functionalities so that the user experience is optimized to be logical and smooth.

2. User Interface

Embodiments of the present invention may be implemented using a variety of user interfaces such as computer mouse operated user interfaces or touch screen operated user interfaces. E-book reader applications according to embodiments of the present invention may be implemented to run on a variety of devices, such as on a desktop or laptop computer (e.g., in a web-browser or a standalone application), on a mobile phone, a tablet computer, a dedicated reading device, or any of a wide range of computing devices. Based on the interface, e.g., mouse-operated or finger-operated, the operations may be slightly different. The overall theme, however, remains the same. Details are presented regarding the user interface objects pertaining to the functionality of the classes, pointing out the minor variations whenever they exist.

2.1 Datahead

Two different example embodiments of the Datahead are discussed below. One embodiment defines the Datahead layout based on a browser-style interface. Referring to FIG. 10, according to one embodiment, the Datahead includes the buttons: previous page 1008, next page 1010, previous section 1002, top of the section 1004, next section 1006, and search 1012. However embodiments of the present invention are not limited thereto. For example, the Datahead may further include a button for navigating to the top of the page.

According to another embodiment of the present invention, the Datahead layout is defined based on category. According to this embodiment, the Datahead includes a search bar 1112 and a drop down menu 1114 allowing selection of a category of item (e.g., sections, figures, equations, and references); as shown in FIG. 11.

The search functionality may have multiple variations. The search could have a text input and a go button, which allows the user to search the entire text for the keywords.

Alternatively, in another embodiment, the search could have an additional drop-down menu to search based on category, e.g., search in the current section, or search only figures, etc.; as shown in FIG. 11.

2.2 Contents and Section/Subsections

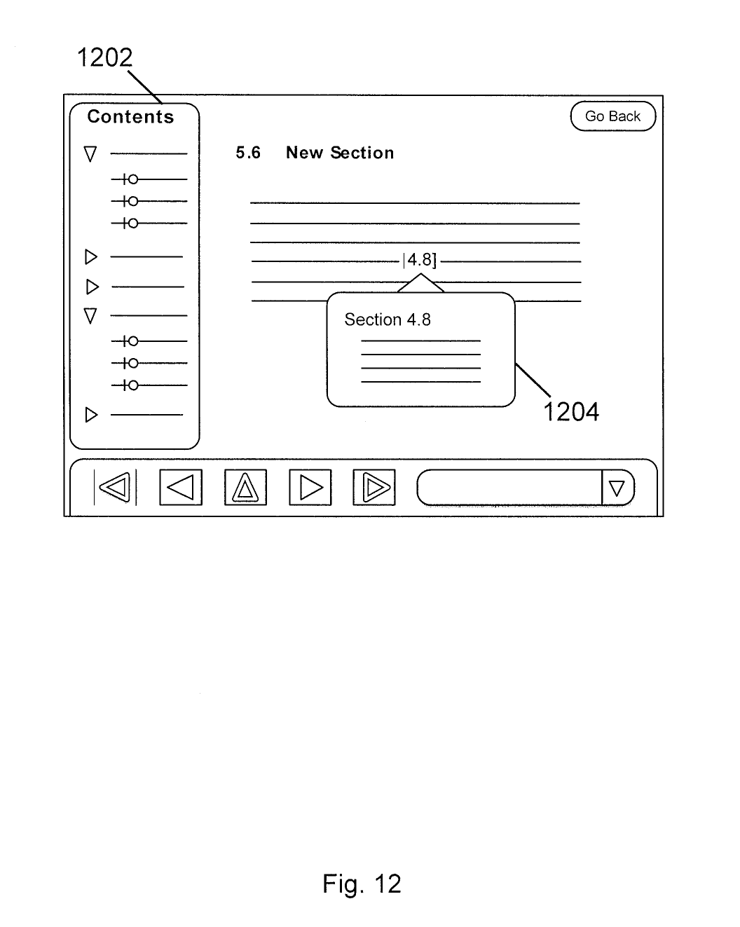

One embodiment of the present invention includes a contents panel (or contents menu) 1202, which slides in and out when the user selects or clicks on the contents or a particular section/subsection. In the menu that slides out, each of the chapters, sections, and subsections are clickable. Clicking on a particular section takes the user to that section. At the same time, the contents panel will slide out of the page/screen (e.g., hide itself). FIG. 12 illustrates the contents and sections menu according to one embodiment of the present invention. Chapters and subsections may also be represented in a substantially similar way.

In addition, when the user moves the mouse over a particular section number that is referred to another location, that particular section could open in a new window, a pop-up window, or as a tool-tip 1204. In all three scenarios, the first few lines or paragraphs of the referred section are shown to the user, as seen in FIG. 12. This could be either in a scaled-down font or regular font. The resolution of the referred section could also be scaled down for the intent of showing it as a tool-tip.

When the user clicks on or selects a particular section number rather than moving the mouse over it, the user is taken to that section. It could be a smooth scroll shown on the application window, a page-wise scroll forward or backward to the corresponding referred section, or a contextual jump.

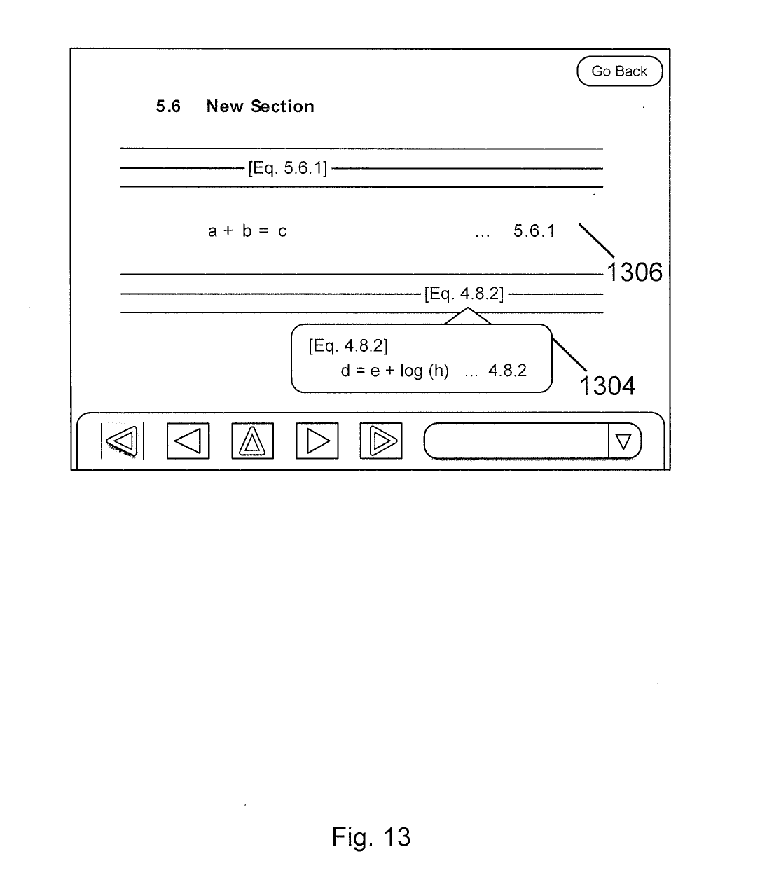

When the user is viewing the referred section, the application treats it as an intermediate state. The application keeps a memory (e.g., a history) of where the user has arrived from, and provides an option to the user to go back to the section he/she was viewing before. This could be provided as a “Go Back” button option either at the top or the bottom of the screen as shown in FIG. 13. The operation of the “Go Back” button could again be a smooth scroll, a page-wise scroll, or a contextual jump.

If the section number that is being referred to is present in the current page itself or view screen, the application could highlight both the section number and section heading in a lighter or brighter shade of the same color, thereby conforming to the same color scheme.

2.3 Equations

Embodiments of the present invention can also provide easy access to referred equations. First, the equations are shown in a different color and/or are more prominent when they are written as text and/or referred to with an equation number. Second, embodiments of the present invention use highlighting the related/corresponding equation while making annotations. And third, embodiments of the present invention make the equations themselves interactive with possible definitions and proofs shown when required. As with the UI used for other classes, this class also separates the usage of mouse-over vs. click selection or finger press.

FIG. 13 is an illustration of a user interface for displaying equations according to one embodiment of the present invention.

Referring to FIG. 13, when the user moves the mouse cursor over the equation number that is referred to in a particular section (e.g., “Eq. 4.8.2” in FIG. 13), there is a distinction made if the equation is present in the current page or view screen versus if the equation is cited elsewhere. If the equation is elsewhere, the equation that is being referred to is shown in a new window, a pop-up window, or as a tool-tip 1304.

However, if the equation number that is referred is present in the current page or view screen, then the action of user moving his mouse over it would highlight the equation (e.g., “Eq. 5.6.1” in FIG. 13). For example, the equation could be highlighted 1306 using a lighter or brighter version of the same color, thereby still conforming to the color scheme. Additionally, both the reference and the equation could be highlighted together to make it easier for the user to identify the connection.

When the user clicks on the equation number that is not present in the current page or the view screen, the application takes the user to the equation. The process could be performed using smooth scroll, page-wise scroll, or contextual jump. As in the UI for other classes, this is considered as an intermediate state by the algorithm a “Go Back” option may be displayed for the user to allow the user to revert back to the original section he/she was viewing before clicking on the equation number.

Additionally, in some embodiments of the present invention, the equation itself is selectable. Clicking on the equation zooms in on it for users to take a closer look. Moving the mouse over the equation could highlight it as well as all the places the equation was referred to in the current page or view screen.

Further enhancements can be provided to the clickable feature of the equations. In one of the embodiments, clicking on it opens the descriptions of the terms in the equation in a new window, a pop-up window, or as a tool-tip.

In another embodiment, the application shows a new window, a pop-up window, or an interactive tool-tip (or more generally, an “overlay”) such that the user (e.g., a student) can click to look at the proof or detailed explanation of the equation.

In another embodiment, the overlay is interactive such that the user (e.g., a student) can enter values for the terms (or variables) of the equation and observe how the result changes. For example, in one embodiment, one or more slider or dial controls allow the user to explore a range of values and an output of the equation (e.g., a number or a graph) would dynamically be updated as the controls were manipulated.

In yet another embodiment, the overlay is interactive such that the user can a source code view of the equation (e.g., the MATLAB, C, Java, Ruby, Lisp, or other programming language) implementation of the equation. This scenario could be true with multi-line equations that together constitute an algorithm.

2.4 Figures

In one embodiment of the present invention, similar functionality is available within the user interface for Figures in the e-book. The references to the figures as well as the figures themselves are clickable and may be interactive.

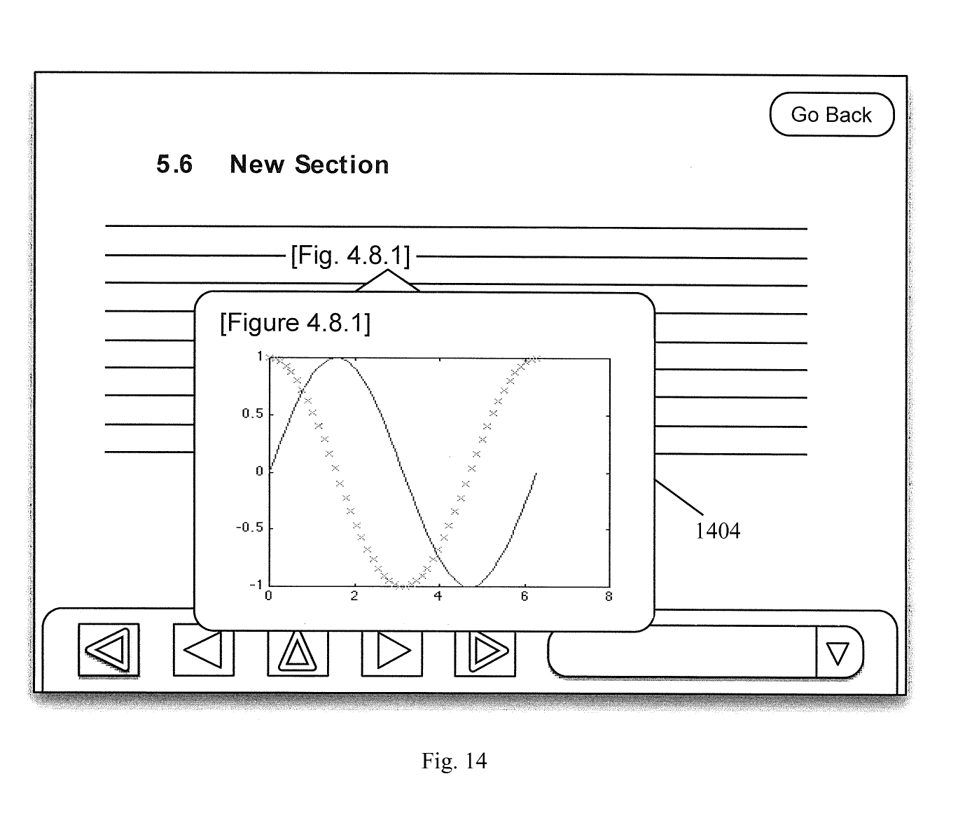

FIG. 14 is an illustration of a user interface for displaying figures according to one embodiment of the present invention.

When the user moves the mouse over on the figure number that is referred to in a particular section, like in the case of the equations class, there is a distinction made if the figure is present in the current page or view screen versus if the figure is shown elsewhere. If the figure is shown elsewhere, the figure that is being referred to is shown in a new window, a pop-up window, or as a tool-tip 1404.

In one embodiment of the present invention, the new window, pop-up or the tool-tip could be made interactive for the user.

If the figure number that is being referred to is present in the current page or view screen, then the action of user moving his mouse over it would highlight the figure. Like in the case of equations, the highlighting could be done using a lighter or a brighter version of the same color that is used for figures. In some embodiments, the highlighting would only be applied to the background of the figure, so as to not disturb the figure itself and/or the color schematics in it.

Additionally, both the reference and the figure could be highlighted together with the same highlighting shade/tone of the predefined color. The highlighting could be applied to all places that the figure is referred to in the current page or view screen.

In one embodiment of the present invention, if the figure number is present in the current page or the view screen, the action of the user moving the mouse over it (or touching it on a touchscreen device) could zoom in on the figure as shown in FIG. 14, giving the user a clearer, higher-resolution picture. This could be done instead of or in addition to highlighting.

When the user clicks on the figure that is not visible in the current page or the view screen, the application takes the user to the section or page where the figure is present. This could be done using scrolling smoothly, or page-wise scrolling, or just a contextual jump. However, this is considered as an intermediate state and there could be a “Go Back” button for the user in this state, for the user to go back to where the figure number was originally clicked.

In one embodiment of the present invention, as in the case of UI for the equations class, the figure itself could be made clickable. Clicking on the figure could zoom in on the figure. This could be particularly useful for plots and graphs for viewing individual lines and legends.

The application could build on the zoom feature. In one embodiment, the zoom feature could be interactive. For example, when clicked, the zoomed version of the figure may open in a new window, a pop-up window, or a tool-tip 1404. However, when the mouse is moved over a particular portion/segment of the figure, only that portion/segment could be zoomed in interactively, e.g., the zoomed-in area changes if the mouse moves over to another portion/segment of the figure.

In another embodiment of the present invention, further enhancements could be provided in the figures. For example, moving the mouse over or clicking a particular line in a graph or plot could provide the user (e.g., a student) with the equation used to draw the line. In another embodiment, the data points responsible for plotting the line could be provided interactively, based on the mouse movements.

In another embodiment of the present invention, the figure is interactive such that the user (e.g., a student) can change a variable in the equation used to plot the graph and observe how the plot changes on screen. This is particularly helpful for learning, for example, statistical analysis mentioned often in engineering and economics texts.

In yet another embodiment, the figure may be interactive such that the user can view, in a pop-up window or a tool-tip, the source code (e.g., MATLAB, C, Java, Ruby, Lisp, or other programming language) implementation of the figure.

For example, according to one embodiment of the present invention, a figure containing a circuit diagram illustrates time varying voltage values at each point in the circuit, where the time and/or an input voltage is controlled via a user interface. In other embodiments, values of circuit components can also be changed and the results of changing those values are also displayed on screen.

According to another embodiment of the present invention, high-level block diagrams of electrical circuits can be expanded to show additional circuit detail. For example, a circuit diagram which included a phase-locked loop as an abstract circuit component could be selected in order to view a definition of the phase-locked loop component, an explanation of how a phase-locked loop works, or a reference to another part of the book in which the phase-locked loop is discussed in further detail.

2.5 References

One aspect of embodiments of the present invention provides a quick and convenient way to view references (e.g., bibliographic or other references to other documents). According to one embodiment, a segmented portion/band of space at the bottom of the current page or the view screen that is two to three lines in height and that spans the entire width of the display is allocated for showing references. This band of space sits above the datahead. It slides open smoothly (like a tray) when needed, and closes itself smoothly when not needed.

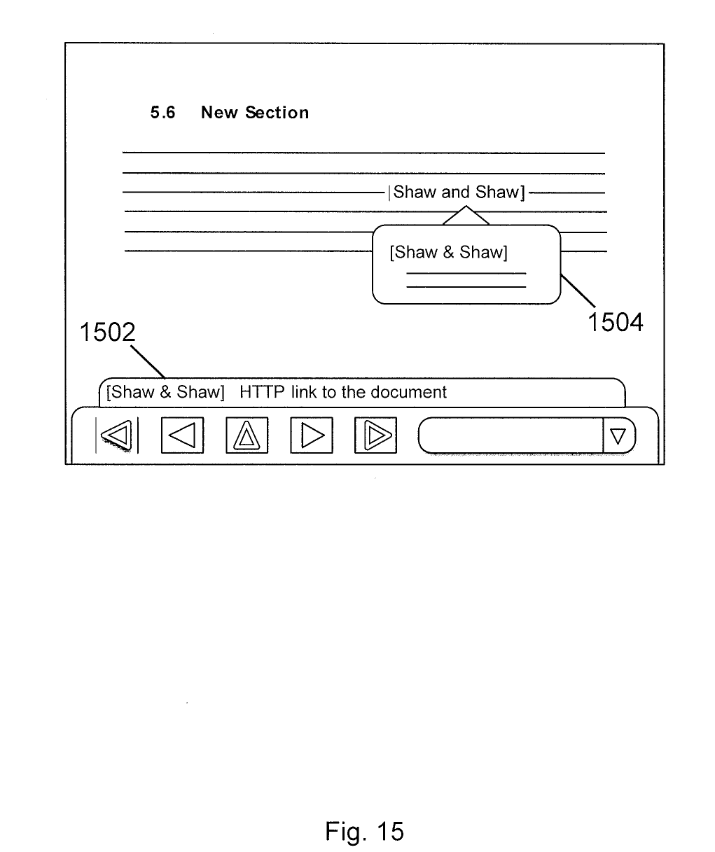

FIG. 15 is an illustration of a user interface for displaying references to other documents according to one embodiment of the present invention.

When the user clicks on a particular reference number or reference author, the reference (the bibliography item) could be displayed in the above-described band of space 1502. Additionally, when the user moves the mouse over a particular reference number or reference author, the reference could be displayed in a new window, a pop-up, or a tool-tip 1504. Both these scenarios are shown in FIG. 15.

Both the band of space 1502 at the bottom that opens up when the reference is clicked as well the tool-tip 1504 that appears when the reference is ‘selected’ by hovering the mouse over it, may be clickable. Clicking on either of these will open a URL or an html link to the reference if one exists.

In one embodiment, the application provides access to common reference publications. Examples of this include:

(a) If the article referred to is a published book, that has been previously rented or purchased by the user in an electronic format and can be accessed using the application,

(b) If the referred to article is a technical journal or a conference paper, that is already on the user's computing device that is running the application,

(c) If the referred to article is from a well-known publisher of technical material, like the IEEE, SPIE, Springer-Verlag, etc. that the user has access to, and can provide credentials.

In the above-mentioned scenarios, clicking on the reference link at the band of space 1502 at the bottom of the current page or view screen could locate and open the reference in a new window, a pop-up window, or as a tool-tip 1504. The application could be implemented such that it understands multiple reference formats, the more common ones including but not limited to: .pdf, .ps, .html, .doc, and .epub.

In another embodiment of the present invention, when the user moves his mouse over either the reference number or the band of space, it could provide the first page of the reference article in a new window, pop-up window, or a tool-tip. Alternatively, it could provide the abstract of the technical article instead of the first page, wherever applicable.

If the reference item that is being referred to by the reference number or the reference author is visible in the current page itself or view screen, the application could highlight both the reference number/author and the reference item in a lighter or brighter shade of the same color.

2.6 Index

One embodiment of the present invention provides an index using a keyword-definition pairing scheme. In this embodiment, the application could also tie the index functionality to the search functionality present in the datahead in every page or viewing screen.

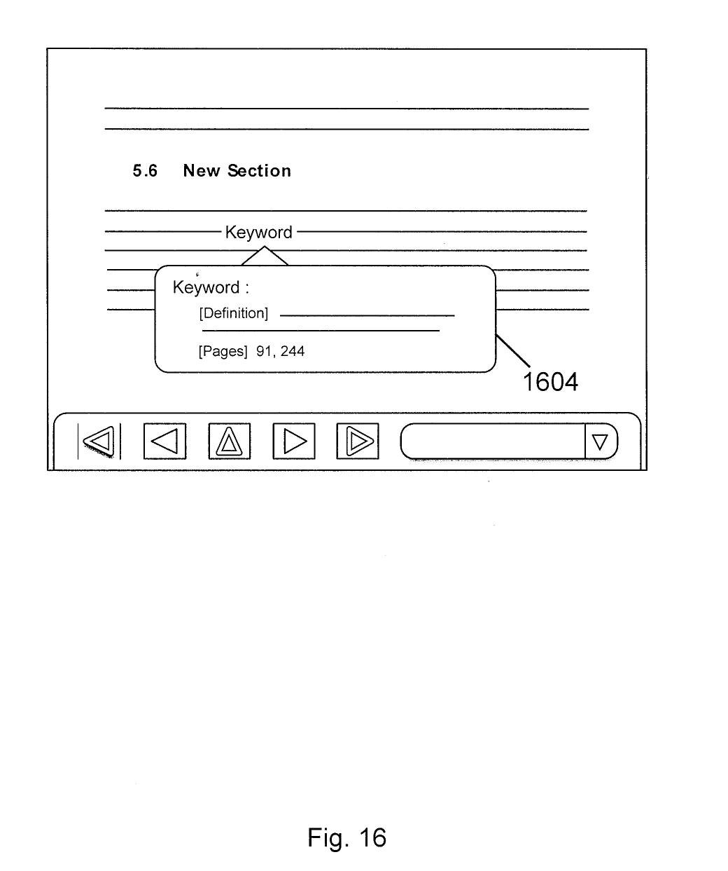

FIG. 16 is an illustration of a user interface for displaying keyword-definition pairings according to one embodiment of the present invention.

According to one embodiment of the present invention, the keyword-definition pairing scheme highlights the keyword when the user moves his/her mouse over it and provides its definition in a new window, a pop-up window, or a tool-tip 1604, as shown in FIG. 16. The highlighting could be based on a specific color used as a background of the keyword, or specific color used as font of the keyword, or an indented box created around the keyword, or just a dotted-outlined box created around the keyword, or any combinations of them.

In one embodiment of the application, following the conventional index, a list of all the page numbers or section numbers that the keyword is listed in could be shown in the new window, pop-up window or the tool-tip 1604.

In another embodiment of the present invention, hovering the mouse over could show the definition; whereas clicking on it could take the user to the section/page/screen that first mentions or defines the keyword. If the keyword and the first time it is defined are in the same page or view screen, then both of them could be simultaneously highlighted in a lighter or a brighter shade of the same color.

In another embodiment of the present invention, the functionality of the index could be tied to the functionality of the search box that is present in the datahead. When the user searches for a keyword, a list of all places the keyword is mentioned (similar to the conventional index) could be shown as the search result.

In yet another embodiment, the result of the search could take the user to the first section/page/view screen the word is mentioned or defined with an option to “Go Back”. When the user clicks on the “Go Back” button, the application smoothly scrolls back, page-wise scrolls back, or jumps to the page or the view screen where the search was performed.

2.7 Other Classes

There are certain aspects in the UI for the proposed e-book reader that may not apply to the generic textbook but are specific to certain categories of texts. For example, computer science textbooks may include computer code on a CD-ROM, or medical textbooks may include highlighted review materials. Examples of additional classes of data include, but are not limited to:

Code

Many computer science and related engineering fields prefer to use texts that have additional programming or software tools attached to them. These are typically distributed in a CD format and include samples of code in various programming languages, or pseudo-code in a particular language that is suitable for the algorithm. In one embodiment, the application provides provisions, based on the user's access constraints (see Section 3), for these kinds of programming tools as part of the e-book reading material.

Bookmarks

In addition to making highlights and taking notes in one embodiment of the application, the user could be allowed to bookmark pages, sections, and chapters. The user could also transfer these bookmarks to other applications such as a browser or a PDF reader that would allow importing bookmarks. Additionally, in another embodiment, the user could be allowed to bookmark certain self-defined selections such as segments of texts, highlighted material, and notes made in a particular page or a section. These bookmarks could be of further help in indexing and storing the said selections.

Review Material

More and more textbooks are including a set of review materials for the students benefit either separately in a CD or part of the text as an extended version. If this comes as part of the text, it is typically included as a highlighted segment or a block of important material in question and answer format. Embodiments of the present invention also incorporate provisions for including the review material also as per the user's access restrictions.

Drill Problems

Some textbooks include practice questions or drill problems included in the textbook. Embodiments of the present invention also incorporate these as well as part of the reading material. The solutions for the problems could be open to the students or hidden such that the student can try the problem on their own and verify the solution with the provided one.

Additional Examples

Recent books come with added examples for the benefit of the student reader. A lot of times, these examples are provided to make certain technical concepts clear. Additionally, these are also used to provide multiple case-scenarios in the legal textbooks. Embodiments of the present invention also incorporate provisions for these additional examples as part of the e-book reading material.

Frequently Asked Questions

Often times, the students or readers of technical texts come across concepts that they want to clarify with the author in more detail. For this reason, more and more textbooks are providing a list of frequently asked questions (FAQs). Embodiments of the present invention cater to these as well as a part of the reading material.

Other classes could be added to the application depending on the topic and scope of the e-book.

Multimedia Tools

Readers of a number of texts, especially legal and medical books, benefit hugely from included multimedia tools. These tools are becoming more prominent these days and being included with the text in a CD or are being made available online. For most part, these include speech, audio, image, and video tools, and can be easily included in electronic format of the book. Embodiments of the present invention also include these tools as part of the e-book reading materials.

Slides

In some cases, the authors choose to provide slides (PowerPoint or Keynote) for the text material as part of teaching aids. These slides help in systematic, sequential, and pragmatic division of the content in the e-book. Typically, teachers/instructors find these materials handy. Embodiments of the present invention also provide these slides to the user, conditional on his/her access restrictions, as part of the e-book materials.

2.8 Highlighting and Notes

In addition to the above-described functionalities, according to one embodiment of the present invention, the user could have access to a highlighter and a note maker (a software implementation of a pencil or a pen). The highlighter could allow the user to highlight a particular phrase, line, sentence, paragraph, or a section. The functionality to highlight could extend to equations and references classes' implementation as well. The highlighted sections could then be indexed and stored for the user's future reference. The indexing could be based on either page numbers or section numbers.

The note maker could allow the user to make a note of his/her thoughts about a particular keyword, phrase, sentence, paragraph, or a section. This could be easily extended to an equation, figure, or a reference. The user could have the capability to make a note using just plain text, rich text that includes mathematical symbol representations and formatting, sketches or figures that the user chooses to draw using the provided note maker tool.

In one embodiment, the note maker could reconnect with the class implementations of the equations, figures, references, and sections such that if the user notes the section number or the figure number in the notes, the respective UI for the class could be called into action.

The note maker could allow inserting the note anywhere in the text (in-between words, sentences, or paragraphs), outside the written or printed area of a page in a book, around figures and equations etc.

Additionally, once a note is placed in a particular area, the user could be allowed to move it around and place it in a different area.

Also, in another embodiment, the note could be made either editable or fixed and the user has the discretion to change this at will.

As in the case of highlighting, the notes made by the note maker could also be indexed and stored for the user's reference. Furthermore, the user could be given access to the stored highlights and notes in multiple formats including but not limited to plain text, rich text, or a pdf file that could be saved locally by the user and accessed independently.

Furthermore, in some embodiments of the present invention, the notes can include references to assets such as equations and figures from other parts of the e-book. In addition, these assets may be copied into the annotation and can be modified or annotated therein.

3. E-Books Access

In some embodiments, the e-book reader can be capable of providing various levels of access to the content. These include:

(a) Access to faculty, which includes access to text, additional and advanced problem sets, solution manuals, implementation code in various programming languages that the e-book supports, etc.,

(b) Access to students, which is much more restricted to the text, limited set of problems, helpful code snippets (not full code) or pseudo-code, other understanding tools, etc.,

(c) Time-based access, which allows users to access it only for a specific period of time, and

(d) Content-based access, which allows users to access other material or texts from the same publisher or same technical communities.

4. Security Considerations

In some embodiments of the present invention, the e-book reader includes security features such as:

(a) Maintains a specific set of restrictions and access options based on the type of user, for example, these restrictions could be different for beginners vs. advanced users, faculty vs. student users, free/standard/premium users, etc.,

(b) Secure login for the user. This process identifies the user based on a unique username and password combination. The password could be encrypted and stored in a secure database using any of the public-key RSAs, secret keys, or Hash-based Message Authentication Codes (HMAC) like SHA-1, MD5, etc.,

(c) Identifies the user re-logins using user's computer's IP address, or Media Access Control (MAC) address, etc. since these are unique, and

(d) Also maintains time and state for the users, which defines constraints and updates for time-based and content-based access restrictions, for example, the access to material goes away after the end of semester, etc.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An electronic book reader comprising:
a computing device comprising:
a memory,
a signal processor,
a user interface, and
a display,
the computing device being configured to display a first portion of an electronic book on a main portion of the display, the electronic book being stored in the memory, the signal processor being configured to load the electronic book from the memory and to display the electronic book on the display, and the electronic book including at least one reference from the first portion of the electronic book to an asset in a second portion of the electronic book, the display being further configured to show the second portion of the electronic book as an overlay when the at least one reference is selected via the user interface.

2. The electronic book reader of claim 1, wherein the computing device is a desktop computer, a laptop computer, a tablet computer, or another mobile computing device.

3. The electronic book reader of claim 1, wherein the asset is a figure.

4. The electronic book reader of claim 3, wherein the figure displayed in the overlay comprises one or more of labels, titles, and legends of the graphs, maps, and diagrams.

5. The electronic book reader of claim 3, wherein the overlay comprises:
a first display configured to display the data point values in a graph/plot in accordance with a user selection;
a second display configured to display the equation used to generate the graph/plot;
a first control configured to set one or more values of one or more of variables of the equation used to generate the graph/plot; and
a second control configured to change the shape of the graph/plot/curve in accordance with the user selection;
wherein the user interface is configured to control the first control and the second control;
wherein the first display is configured to dynamically update the display of the graph/plot in accordance with the one or more values of the one or more variables of the equation set by the first control; and
wherein the second display configured to dynamically update the display of the equation in accordance with the one or more values of the one or more variables of the equation set by the first control.

6. The electronic book reader of claim 1, wherein the asset is an equation.

7. The electronic book reader of claim 6, wherein the equation displayed in the overlay includes definitions of variables of the equation.

8. The electronic book reader of claim 6, wherein the overlay comprises:
a control configured to set a value of the equation displayed in the overlay; and
a display configured to display an evaluated output of the equation in accordance with a value set by the control, and
wherein the user interface is configured to control the control.

9. The electronic book reader of claim 1, wherein the asset is a section of the electronic book.

10. The electronic book reader of claim 1, wherein the memory is configured to store a searchable index of words in the electronic book, wherein the searchable index of words associates each of a plurality of words to one or more locations in the electronic book.

11. The electronic book reader of claim 10, wherein the computing device is further configured to receive a search query entered via the user interface, and
wherein the computing device is further configured to return a list of locations in the electronic book, the list of locations corresponding to the search query.

12. The electronic book reader of claim 10, wherein the asset is an entry in a glossary stored in the searchable index of words.

13. The electronic book reader of claim 1, wherein computing device is further configured to display the second portion of the electronic book on the main portion of the display in response to a command received from the user interface.

14. The electronic book reader of claim 1, wherein the computing device is configured to control the display to indicate the one or more references on the display based on a type of the asset.

15. The electronic book reader of claim 14, wherein a reference of the one or more references is displayed in a first color when the asset is a figure and wherein another reference of the one or more references is displayed in a second color different from the first color when the asset is an equation.

16. The electronic book reader of claim 1, wherein the memory is further configured to store an annotation received from the user interface and associated with the first portion of the electronic book.

17. The electronic book reader of claim 16, wherein the annotation includes a reference to the asset.

18. The electronic book reader of claim 16, wherein the annotation includes a copy of the asset.

19. The electronic book reader of claim 16, wherein the annotations of same type of assets are combined together for storage.

20. The electronic book reader of claim 1, wherein the asset is associated with an asset security restriction,
wherein the user interface is configured to receive login credentials for a user account associated with one or more account security restrictions, and
wherein the computing device is configured to grant or deny access to the asset in accordance with the asset security restriction and the one or more account security restrictions associated with the user account.

21. The electronic book reader of claim 1, wherein the asset is a bibliographical reference, an online reference, or a reference to another electronic book that is stored in the memory.

22. The electronic book reader of claim 1, wherein the asset comprises a software program.

23. The electronic book reader of claim 1, wherein the asset comprises practice problems, practice exercises, or review materials.

24. The electronic book reader of claim 1, wherein the asset comprises supplemental slides.

25. The electronic book reader of claim 1, wherein the asset comprises audio, video or other multimedia material.

26. The electronic book reader of claim 1, wherein the computing device is configured to control the display to indicate the location of the asset on the display based on the asset being in the first potion of the electronic book or the second portion.
